(19) United States
(12) Patent Application Publication
(10) Pub. No.: US 2001/0042375 A1
(43) Pub. Date: Nov. 22, 2001

(54) Gas turbine combustor

(76) Inventors: Koichi Nishida, Takasago-shi (JP); Katsunori Tanaka, Takasago-shi (JP); Shigemi Mandai, Takasago-shi (JP); Yutaka Kawata, Takasago-shi (JP); Masataka Ohta, Takasago-shi (JP)

Correspondence Address: WENDEROTH, LIND & PONACK, L.L.P., 2033 K STREET N. W., SUITE 800, WASHINGTON, DC, 20006-1021, US

(21) Appl. No.: 09/828,138

(22) Filed: Apr. 9, 2001

(30) Foreign Application Priority Data
May 19, 2000 (JP) 2000-147241

(51) Int. Cl. F02C 3/30

(52) U.S. Cl. 60/737; 60/748

(57) ABSTRACT

To present a gas turbine combustor capable of improving the fuel distribution from the main fuel nozzle, suppressing fluctuations of internal pressure and elevation of inner tube metal temperature, and enhancing the combustion stability and durability of the combustor. A gas turbine combustor used in a gas turbine having a multi-nozzle type premixing combustor with a nozzle outer tube (7) for forming and injecting a premixed gas of main fuel and combustion air divided and disposed in plural sections around a cone (4) for forming a diffusion flame by reaction between pilot fuel and combustion air disposed in a center of a section of a combustor inner tube (1), in which nozzle holes (5a) of a main fuel nozzle (5) are formed in three positions at equal intervals on the nozzle main body wall, and one of them is disposed at the outer periphery of the combustor inner tube (1) on the diametral line linking between the center of the combustor inner tube (1) and the center of the main fuel nozzle (5), and the fuel distribution to the outer periphery is decreased.

### BACKGROUND OF THE INVENTION

1. Field of the Invention

The present invention relates to a gas turbine combustor, and more particularly to a multi-nozzle type premixing combustor.

2. Description of the Related Art

Recently, the gas turbine combustor, for example, the steam cooling type combustor capable of realizing low NOₓ even in the gas turbine of 1500° C. class is attracting a wide attention. That is, by cooling the combustor wall by steam, the air hitherto used for cooling of wall can be used for combustion, and the premixed combustion temperature is suppressed to a level of air-cooled combustor in spite of temperature elevation in the gas turbine, sot that low Noₓ is realized.

As such steam cooled combustor, a conventional example of multi-nozzle type premixing combustor as shown in FIG. 5 is known, in which a nozzle outer tube 7 for forming and injecting a premixed gas of main fuel from a main fuel nozzle 5 and combustion air from main swirler 6 is divided and disposed in plural sections around a cone 4 for forming a diffusion flame by reaction between the pilot fuel from a pilot fuel nozzle 2 and combustion air from a pilot swirler 3, being disposed in the center of the section of a combustor inner tube 1.

In the main fuel nozzle 5, as shown in FIG. 4, the fuel is injected from plural nozzle holes 5a (about 1.0 mm in diameter) opened in the nozzle main body wall, and is mixed with the air flowing in the nozzle outer tube through the main swirler 6, thereby forming a premixed gas.

In FIG. 4 and FIG. 5, the arrow shows the flow of fuel and air.

However, in such conventional multi-nozzle type premixing combustor, as shown in FIG. 3, since the nozzles holes 5a of the main fuel nozzle 5 are formed in three positions on the outer periphery of the combustor inner tube 1 and in two positions at the inner side, the fuel distribution to the outer periphery increases, and it may bounce on an elliptical extended pipe 7a (which is provided for preventing back-fire by raising the gas flow velocity) due to circumferential flow by swirl flow by swirler, and may collide against the wall of the combustor inner tube 1 (see arrow in FIG. 3).

As a result, fuel liquid drops may deposit on the wall of the combustor inner tube 1 (see hatching (b) in FIG. 3), and internal pressure fluctuates to spoil combustion stability, or the metal temperature is raised by self-ignition, thereby breaking the wall of the combustor inner tube 1 (see broken part (a) in FIG. 3).

### SUMMARY OF THE INVENTION

The invention is devised in the light of such background, and it is hence an object thereof to present a gas turbine combustor capable of improving fuel distribution from main fuel nozzle, suppressing internal pressure fluctuation and elevation of inner tube metal temperature, and realizing combustion stability and improvement of durability of combustor.

To achieve the object, the gas turbine combustor of the invention is a gas turbine combustor used in a gas turbine having a multi-nozzle type premixing combustor with a nozzle outer tube for forming and injecting a premixed gas of main fuel and combustion air divided and disposed in plural sections around a cone for forming a diffusion flame by reaction between pilot fuel and combustion air disposed in a center of a section of a combustor inner tube, in which nozzle holes of a main fuel nozzle for injecting the main fuel are opened and formed more at the inner side than at the outer periphery of the combustor inner tube in the nozzle main body wall, and the fuel distribution to the outer periphery is decreased.

### BRIEF DESCRIPTION OF THE DRAWINGS

FIG. 1 is an essential front view of a gas turbine combustor showing an embodiment of the invention:

FIG. 2 is a side sectional view of its main fuel nozzle;

FIG. 3 is an essential front view of a conventional gas turbine combustor:

FIG. 4 is a side sectional view of its main fuel nozzle; and

FIG. 5 is a general structural view of a multi-nozzle type premixing combustor thereof.

### DETAILED DESCRIOTION OF THE PREFERRED EMBODIMENT

A gas turbine combustor of the invention is described below by referring to a preferred embodiment thereof taken in conjunction with the accompanying drawings.

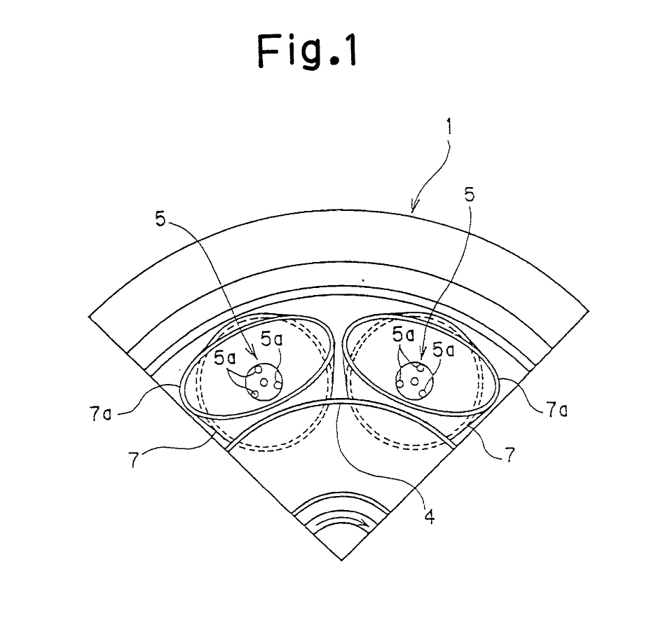

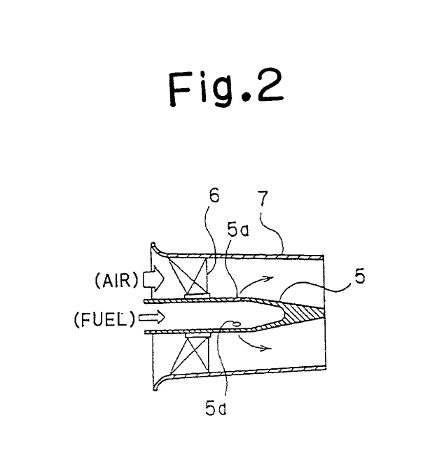

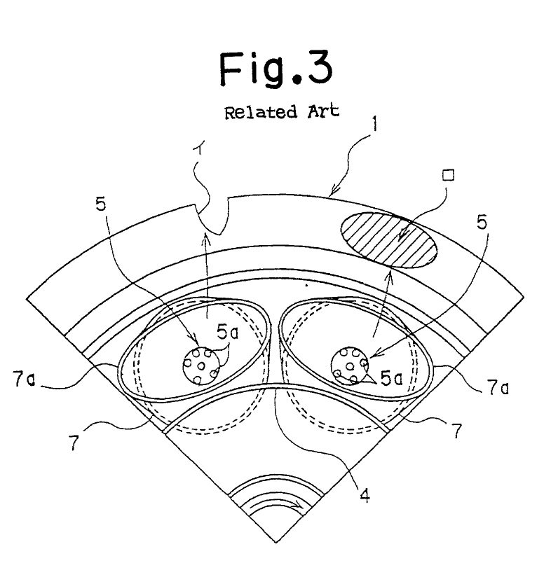

FIG. 1 is an essential front view of a gas turbine combustor showing an embodiment of the invention, and FIG. 2 is a side sectional view of its main fuel nozzle. The entire structure of the combustor is shown in FIG. 5, and detailed description is omitted.

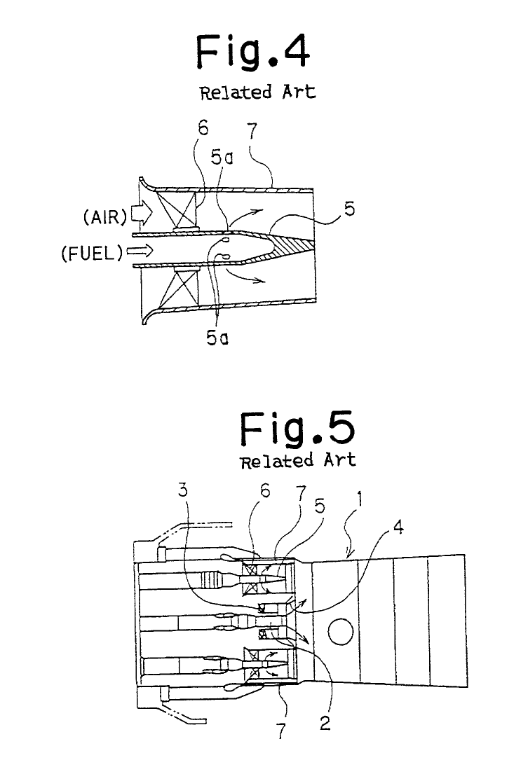

As shown in FIG. 2, a main fuel nozzle 5 is disposed in the center of the section of a nozzle outer tube 7, and a main swirler 6 is disposed in a peripheral gap between the nozzle main body outer periphery of this main fuel nozzle 5 and the inner periphery of the nozzle outer tube 7, and so far the structure is same as shown in FIG. 4.

In this embodiment, as shown in FIG. 1, in the main fuel nozzle 5, the fuel is injected from three nozzle holes 5a (about 1.3 mm in diameter in this embodiment) opened in the nozzle main body wall, and is mixed with the air flowing around the nozzle outer periphery through the main swirler 6, so that a premixed gas is formed.

In the shown example, the three nozzle holes 5a are disposed at intervals of 120 degrees, and one of them is disposed at the outer side of the combustor inner tube 1 on a diametral line linking the center of the combustor inner tube 1 and the center of the main fuel nozzle 5. These nozzle holes 5a are opened at an inclination of about 20 degrees to the downstream side of the gas flow.

Having such configuration, in the main fuel nozzle 5 one nozzle hole 5a is disposed at the outer side of the combustor inner tube 1, and two at the inner side, so that the fuel distribution to the outer side is decreased from that of the inner side.

Accordingly, a swirl flow of a favorably mixed premixed gas is obtained, thereby suppressing collision against the wall of the combustor inner tube 1 of the flammable premixed gas due to bouncing on the elliptical extended pipe 7a by the peripheral flow of swirl flow of the main swirler 6 as experienced in the prior art.

As a result, a stable combustion state is obtained, thereby avoiding loss of combustion stability due to fuel liquid drops sticking to the wall surface of the combustor inner tube 1 to induce internal pressure fluctuations or burning of wall of the combustor inner tube 1 due to elevation of metal temperature by self-ignition.

The invention is not limited to the illustrated embodiment alone, but may be changed and modified in the number of nozzle holes, opening positions, and others so far as not departing from the true spirit of the invention.

As described specifically in the embodiment, the invention according to a first aspect is a gas turbine combustor used in a gas turbine having a multi-nozzle type premixing combustor with a nozzle outer tube for forming and injecting a premixed gas of main fuel and combustion air divided and disposed in plural sections around a cone for forming a diffusion flame by reaction between pilot fuel and combustion air disposed in a center of a section of a combustor inner tube, in which nozzle holes of a main fuel nozzle for injecting the main fuel are opened and formed more at the inner side than at the outer periphery of the combustor inner tube in the nozzle main body wall, and the fuel distribution to the outer periphery is decreased, and therefore the fuel distribution from the main fuel nozzle is improved, fluctuations of internal pressure and elevation of inner tube metal temperature are suppressed, and hence the combustion stability and durability of the combustor are enhanced.

Further, in the invention according to a second aspect, the nozzle holes are formed in three positions at equal intervals on the nozzle main body wall, and one of them is disposed at the outer periphery of the combustor inner tube on the diametral line linking between the center of the combustor inner tube and the center of the main fuel nozzle, and therefore the same effect and action as in the invention according to a first aspect are obtained.

What is claimed is:

1. A gas turbine combustor used in a gas turbine having a multi-nozzle type premixing combustor with a nozzle outer tube for forming and injecting a premixed gas of main fuel and combustion air divided and disposed in plural sections around a cone for forming a diffusion flame by reaction between pilot fuel and combustion air disposed in a center of a section of a combustor inner tube, wherein nozzle holes of a main fuel nozzle for injecting the main fuel are opened and formed more at the inner side than at the outer periphery of the combustor inner tube in the nozzle main body wall, and the fuel distribution to the outer periphery is decreased.

2. The gas turbine combustor according to claim 1, wherein said nozzle holes are formed in odd- number positions at nearly equal intervals on the nozzle main body wall, and one of them is disposed at the outer periphery of the combustor inner tube on the diametral line linking between the center of the combustor inner tube and the center of the main fuel nozzle.

3. The gas turbine combustor according to claim 2, wherein said nozzle holes are formed in three positions at nearly equal intervals on the nozzle main body wall, and one of them is disposed at the outer periphery of the combustor inner tube on the diametral line linking between the center of the combustor inner tube and the center of the main fuel nozzle.
